(19) United States
(12) Patent Application Publication
(10) Pub. No.: US 2019/0371252 A1
(43) Pub. Date: Dec. 5, 2019

(54) DISPLAY DEVICE AND DISPLAY METHOD

(71) Applicant: Lenovo (Beijing) Co., Ltd., Beijing (CN)

(72) Inventor: Baoyu LIU, Beijing (CN)

(21) Appl. No.: 16/427,614

(22) Filed: May 31, 2019

(30) Foreign Application Priority Data
May 31, 2018 (CN) 201810552611.5

(51) Int. Cl. G09G 3/34

(52) U.S. Cl. CPC G09G 3/34; G09G 2310/027; G09G 2320/0233; G09G 2320/103; G09G 2320/0686

(57) ABSTRACT

The present disclosure provides a display apparatus including an interface device, an adjustment device, a light-emitting device, and a display device. The interface device can obtain a first image including a plurality of partial images, each of which corresponds to an initial display parameter. The adjustment device can adjust the initial display parameter corresponding to a partial region of the first image to an adjusted display parameter, where the partial region corresponds to at least one of the plurality of partial images. The light-emitting device can generate initial light. The display device is located in an illumination region of the initial light, and includes a plurality of display sub-devices, each of which can display according to a display parameter. A display sub-device corresponding to the partial region can display according to the adjusted display parameter, and a display sub-device not corresponding to the partial region can display according to the initial display parameter.

### CROSS-REFERENCE TO RELATED APPLICATION

This application claims priority of Chinese Patent Application No. 201810552611.5, filed on May 31, 2018, the entire content of which is incorporated herein by reference.

### TECHNICAL FIELD

The present disclosure relates to the field of display of electronic devices and, in particular, to a display device and a display method

### BACKGROUND

With continued improvement of aesthetics, display devices tend to be thinner and lighter. Display devices with direct-type display can display color better. However, the thickness of the display devices with existing display methods are often not satisfactory. When the display devices become thinner and lighter, the display effect of one part of the display region of the display device is usually different from the display effect of another region.

### SUMMARY

In accordance with the disclosure, one aspect of the present disclosure provides a display apparatus including an interface device, an adjustment device, a light-emitting device, and a display device. The interface device can obtain a first image. The first image includes a plurality of partial images, each of the plurality of partial image corresponding to an initial display parameter. The adjustment device can adjust the initial display parameter corresponding to a partial region of the first image to an adjusted display parameter, where the partial region corresponds to at least one of the plurality of partial images. The light-emitting device can generate initial light. The display device is located in an illumination region of the initial light. The display device includes plurality of display sub-devices, and each of the plurality of display sub-devices can display according to a display parameter. A display sub-device corresponding to the partial region can display according to the adjusted display parameter, and a display sub-device not corresponding to the partial region can display according to the initial display parameter.

Also in accordance with the disclosure, another aspect of the present disclosure provides a display method. The method includes obtaining a first image, where the first image includes a plurality of partial images, each of the plurality of partial image corresponding to an initial display parameter, and adjusting the initial display parameter corresponding to a partial region of the first image to an adjusted display parameter. The partial region corresponds to at least one of the plurality of partial images. One of the plurality of partial images corresponding to the partial region is displayed according to the adjusted display parameter. One of the plurality of the partial images not corresponding to the partial region is displayed according to the initial display parameter.

Also in accordance with the disclosure, another aspect of the present disclosure provides a display method. The method includes obtaining a first image, where the first image includes a plurality of partial images; displaying one of the plurality of partial images not corresponding to a partial region according to a first display parameter; and displaying one of the plurality of partial images corresponding to the partial region according to a second display parameter different from the first display parameter, where the partial region corresponds to at least one of the plurality of partial images.

### DESCRIPTION OF THE DRAWINGS

FIG. 1 is a schematic structural diagram of a display device according to some embodiments of the present disclosure.

FIG. 2 is a flowchart of a display method according to some embodiments of the present disclosure.

FIG. 3 is a flowchart of an implementation manner of a display method according to some embodiments of the present disclosure.

FIG. 4 is a flowchart of another implementation manner of a display method according to some other embodiments of the present disclosure.

### DETAILED DESCRIPTION

Various aspects and features of the present disclosure are described herein with reference to the drawings.

The embodiments described in the present disclosure are examples of the present disclosure but not to limit the present disclosure. Various modifications may be made to the embodiments of the disclosures by those skilled in the art. These modifications shall fall within the scope and spirit of the disclosure.

The embodiments of the present disclosure are described by the accompany drawings. The above summary and the detail descriptions below are intended to describe the principle of the present disclosure.

The descriptions about some embodiments of the present disclosure with references to the accompany drawings are not to limit the present disclosure, but to describe the features of the present disclosure. Other features of the present disclosure can also be obtained based on the descriptions.

Although, the present disclosure is described with reference to the specific embodiments, those skilled in the art can also obtain other substitutive manners based on these described embodiments. These substitutive manners shall fall within the scope of the present disclosure.

All aspects, features, and advantages of the present disclosure are described by the detailed descriptions below with reference to the accompany drawings.

The embodiments of the disclosure are merely examples of the disclosure, which can be implemented in various ways. The well-known and/or repeated functions and structures are not described in detail to avoid unnecessary details. The specific structural and functional details of the present disclosure are not intended to limit the present disclosure but are merely used as representative examples to teach those skilled in the art to use the disclosure in any suitable implementation manner.

Some phrases, e.g., “in one embodiment,” “in another embodiment,” “in another embodiment,” “in some embodiments,” or “in some other embodiments,” may refer to one or more embodiments of the present disclosure.

At present, a display device, e.g., a television, is designed to be thinner and thinner. However, if a television is too thin, in a region illuminated by a light-emitting diode (LED) backlight source, a gray sale is stronger in the center but weaker in the edges. To solve the above problem, a currently used method is to add more LED backlight sources, more diffusion plates and various films (or filters) to uniformly disperse the light to all positions of a screen. However, adding more LED light sources can cause an increased power consumption and production cost. In addition, the diffusion plates and films (or filters) may not have sufficient adjustment capability, which cause the gray scale of the region illuminated by the LED backlight sources to not be uniform. For example, the gray scale is stronger in the center but weaker in the edges of the region.

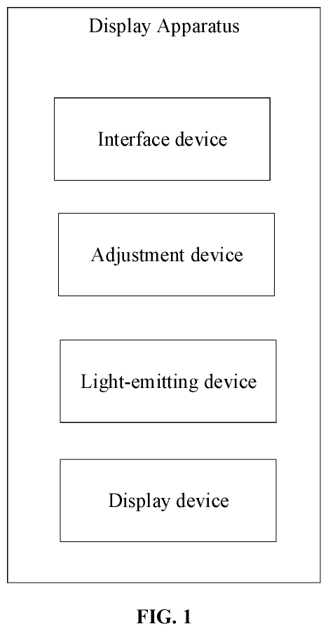

To solve the above problem, the present disclosure provides a display apparatus according to some embodiments of the present disclosure. FIG. 1 is a schematic structural diagram of a display apparatus according to some embodiments of the present disclosure. The display apparatus includes an interface device, an adjustment device, a light-emitting device, and a display device.

The interface device can obtain a first image, where the first image includes a plurality of partial images. Each partial image has a corresponding initial display parameter. The display apparatus may be connected to the electronic device through the interface device. In some embodiments, the interface device may be a wired interface device. For example, the display apparatus can be connected to the electronic device in a wired manner. In some other embodiments, the interface device may be a wireless interface device. For example, the display apparatus can be connected to the electronic device in a wireless manner. In some embodiments, the interface device can be used as a display interface to enable the display apparatus to display based on received display data. In some other embodiments, the interface device can also be used as a general-purpose data interface to enable the display apparatus to interact with the electronic device. In some embodiments, the interface device may be one type or a combination of various types of interfaces of the display apparatus. The interface device may be an HDMI interface, a VGA interface, a DP interface and/or a USB interface, etc. The first image may be an image to be displayed by the display apparatus. The first image may include the plurality of partial images. The plurality of partial images may include an image having a display effect is different from that of other regions in the first image. As such, the display of the first image can be partially adjusted. Each partial image can be displayed according to the display parameter. The plurality of partial images and other images of the first image can be displayed based on the display parameter.

The adjustment device can adjust an initial display parameter corresponding to a partial region of the first image to an adjusted display parameter, where the partial region corresponds to at least one of the plurality of partial images.

The display device may have various structural configurations. The thin and light display device may include LED backlight sources. The LED backlight sources can illuminate light. Without being adjusted by the adjustment device, the display device can display according to initial display parameter. Due to the limitation of the structure (e.g., the thin and light structure) of the display device, the actual display effect of background lights illuminated by the light-emitting device may not be uniform in partial regions. For example, the gray scale of the partial regions of the region illuminated by the LED backlight source is not uniform, for example, stronger in the center but weaker in the edges. For another example, a color display effect in partial regions is different from that a color display effect in other regions. In some embodiments of the present disclosure, the adjustment device can adjust the initial display parameters corresponding to the partial regions to the adjusted display parameter. The display device can performance display in the partial regions according to the adjusted display parameter, so as to adjust the display effect in the partial regions of the first image. The adjusted display parameters can be obtained in different manners. In some embodiments, the adjusted display parameters can be obtained according to the type of the display device and some corresponding empirical data. In some other embodiments, the adjusted display parameters can be obtained using the initial display parameter. For example, when the first image is displayed according to the initial display parameters, the display effect of the first image may not be uniform. Based on the display effect, the value of the initial display parameter is gradually changed until the display effect displayed by the display device is unified, thereby obtaining the adjusted display parameter.

The light-emitting device can generate initial light. The light-emitting device may include a single light-emitting unit to generate the initial light. The light-emitting device may include a plurality of light-emitting units, where each light-emitting unit generates respective light. The light-emitting device may include different kinds of light-emitting sources, for example, the LED light source (an LED light bulb). The backlight emitted by the light source of the light-emitting device can illuminate on an illumination region, so as to allow the display device to use the backlight for display. For example, the display device can use the backlight to vary a brightness of a pixel displayed by the display device. For the light-emitting devices with different configurations, the light-emitting source thereof may be different. For example, the display device may be a display device with a direct-type structure, or a display device with a side-type structure. The light-emitting device may include a plurality of LED light sources (e.g., LED light bulbs). The plurality of LED light sources for emitting backlight can be arranged uniformly at an inner side of the display device, or arranged uniformly on edges of the display device. In some embodiments, main features of each LED light source may be similar. For example, the light emitted by each LED light source can be emitted with the same brightness, but the illumination direction or angle of the emitted light can be different and set according to actual application.

The display device is located in the illumination region of the initial light, and includes a plurality of display sub-devices. In some embodiments, a display sub-device may refer to a pixel or a group of pixels. In some embodiments, each display sub-device can display according to its specific display parameter, so that the viewer can perceive the image light corresponding display parameters. The display sub-devices corresponding to the partial regions can display according to the adjusted display parameters, and the display sub-devices not corresponding to the partial regions can display according to the initial display parameters. After the initial light illuminates on the display device, the display device can use the initial light illuminating thereon for display. In some embodiments, the display device includes a plurality of display sub-devices, each of the plurality of display sub-devices can use the initial light for display. All of the display sub-devices are displayed to form an image for the viewer to review. During display, each display sub-device can display according to the display parameter. Display sub-devices corresponding to different display parameters may have different display effects. The viewer can perceive the image light of the corresponding display parameter. When the corresponding display parameter changes, the image light perceived by the viewer is also different. In some embodiments, the display sub-devices corresponding to the partial regions can display according to the adjusted display parameters, and the display sub-devices not corresponding to the partial regions can display according to the initial display parameters. As such the display sub-device of the corresponding partial regions performs display according to the adjusted display parameter, the actual display characteristics (such as gray scale or color, etc.) of the partial region can be improved.

In some embodiments, the light-emitting device includes a plurality of light-emitting units for generating light. The light-emitting unit may be a single LED or other type of light source, and one light-emitting unit can illuminate a certain region. For example, in a direct-type liquid crystal display device, the light-emitting device may include a plurality of LED light sources (e.g., LED light bulbs). The plurality of LED light sources for emitting backlight can be arranged uniformly at an inner side of the display device. Each LED light source can emit backlight, and all the light generated by the LED light can illuminate the entire display device.

A light-emitting unit may correspond to a set of display sub-devices, the display sub-device set including at least one display sub-device. The set of display sub-device is located in an illumination region of the at least one light-emitting unit. In some embodiments, the display sub-device may correspond to one pixel, and the set of display sub-devices may correspond to a set of a plurality of adjacent pixels. One light-emitting unit corresponds to one set of display sub-devices and the set of display sub-devices is in the illumination region of the light-emitting unit. At least one light-emitting unit can provide backlight to the corresponding display sub-device.

In some embodiments, when the display sub-device corresponding to the partial region displays according to the adjusted display parameter, there may be certain amount of second backlight transmitted (e.g., the display sub-device has the second backlight). For example, different display parameters correspond to different backlight transmission amount. When the display sub-device displays according to different display parameters, the corresponding backlight transmission amounts are different, which results in different display effects (e.g., different display features).

If the display sub-device of the corresponding partial region displays according to the initial display parameter, the display sub-device transmits a first backlight transmission amount. The second backlight transmission amount is larger than the first backlight transmission amount. In some embodiments, when the display parameter is the same, the backlight transmission amount of display sub-device corresponding to the partial region may vary after the structure of the display device changes (e.g., from a thicker thickness to a thinner thickness). Generally, the structural of the display device (such as a thin thickness) may cause the backlight transmission amount of the partial region is relatively low. For example, when the display sub-device corresponding to the partial region displays according to the initial display parameter, the backlight transmission amount (e.g., the first backlight transmission amount) of the partial region may be relatively low. When the display sub-device corresponding to the partial region displays according to the adjusted display parameter, the backlight transmission amount (e.g., the second backlight transmission amount) of the partial region may be increased. The second backlight transmission amount is larger than the first backlight transmission amount, and the gray scale corresponding to the second backlight transmission amount is higher than the gray scale corresponding to the first backlight transmission amount. In other regions other than the partial regions of the first image, when the structure of the display device changes (e.g., the thickness changes from thick to thin), the backlight transmission amount of the display sub-device may be changed a little or may not be changed. When the partial region displays according to the adjusted display parameter, the second backlight transmission amount of the partial region may be the same as or similar to the backlight transmission amount of the other regions. It should be noted that when comparing the backlight transmission amount with the display sub-devices corresponding to other regions, the backlight transmittance may be the same or similar, when both are displayed according to the same display parameters. For example, when the display sub-device corresponding to the partial regions display in red, and the display sub-devices corresponding to other regions also displays in red, the backlight transmission amounts of the two are the same or similar. Thereby, the partial region can be adjusted, such that the gray scale (brightness) actually displayed in the partial region can be the same as or similar to the other regions. In this way, the entire display gray scale of the first image can be the same or similar.

In some embodiments, the display parameter may include a color parameter and/or a gray scale parameter.

The adjustment device is further configured to adjust the initial gray scale parameter corresponding to the partial region to the adjusted gray scale parameter; and/or adjust the initial color parameter corresponding to the partial region to the adjusted color parameter. In some embodiments, the adjustment device may adjust the gray scale, or the color displayed by the display device. The adjustment device can adjust the initial display parameter to the adjusted display parameter, so that the display device adjusts the color or the gray scale of the display device according to the adjusted display parameter. After the adjustment device adjusts the initial gray scale parameter to the adjusted gray scale parameter, the display sub-device of the partial region displays according to the adjusted gray scale parameter, thereby completing the gray scale adjustment. For example, the gray scale can be adjusted by increasing gray scale by a certain percentage of the initial gray scale. As such the brightness of the image displayed by the display sub-device corresponding to the partial region can be coordinated with the brightness of the image displayed by the display sub-device corresponding to the other region. After the adjustment device adjusts the initial color parameter to the adjusted color parameter, the display sub-device of the partial region displays according to the adjusted color parameter, thereby completing the color adjustment. For example, each display sub-device includes three display sub-units, and the three primary colors of red, green and blue are respectively displayed through the color filter. Through the adjustment of the ratio of the three primary colors, the color of the full color mode can also be displayed. When the display sub-device displays one of the primary colors, the backlight throughput corresponding to the display sub-devices of the other primary colors is adjusted to cause a change in the color of the display sub-device, thereby realizing color adjustment. The overall gray scale of the display device is unified during display, and the display effect can be enhanced even if the display device has an ultra-thin structure.

The adjustment device may include a converting unit. The converting unit can process data driving signal corresponding to the initial display parameter into an updated data driving signal based on the adjusted display parameter, and send the updated data driving signal to the display device. As such the display sub-device can be driven by the updated data driving signal to display. In some embodiments, the display parameter cannot be directly used to drive the display device. The converting unit can convert the display parameter into the corresponding data driving signal, and the data driving signal can be directly used to drive the display device, which includes driving the display sub-device corresponding to the partial region, or driving the display sub-device corresponding to other regions. After the converting unit processes data driving signal corresponding to the initial display parameter into an updated data driving signal based on the adjusted display parameter, the updated data driving signal may be called each time the display device is powered on. For example, the adjustment device transmits the updated data driving signal to the display device, such that the display device uses the updated data driving signal to display. The display sub-device corresponding to the partial region can uses the updated data driving signal to display the partial region.

In some embodiments, the display apparatus further includes a storage device. The storage device is configured to store an updated program for generating the updated data driving signal. After the updated program is executed, the corresponding updated data driving signal can be generated. The storage device may be a stand-alone device capable of storing the updated program separately, or may be a device shared with other devices to store a variety of data including the updated program. In some embodiments, the storage device may be a device such as an EEPROM in the display apparatus, and the updated program may be burned into the EEPROM.

The adjustment device can call the updated program from the storage device, and generate an updated data driving signal according to the initial program and the updated program, and drive each display sub-device separately by using the updated data driving signal. For example, after the display apparatus initiates or receives a command, the display apparatus calls the updated program from the storage device (e.g., from the EEPROM). In some embodiments, the adjustment device loads the updated program into the initial program after calling the updated program, thereby changing the initial program. For example, after the adjustment device loads the updated program into the initial program, partial program segments in the initial program can be adjusted, added, and/or deleted, etc., so as to change the signal generated by executing the program. In some embodiments, after the updated program is loaded, the initial program can be changed to a current program, and the updated data driving signal can be generated after the current program is executed. In some other embodiments, the updated program and the initial program are executed to generate a first data driving signal and a second data driving signal, respectively. The first data driving signal is first used to drive the display device. After all the display sub-devices display, the second data driving signal is used to drive the display device to display, and to adjust a display status of a part of the display sub-devices. A result of executing the program (e.g., executing the initial program, the updated program, and/or the current program) can be digital signal. The updated data driving signal can be an analog signal. The data signal can be converted into the corresponding analog signal by a driving chop. Each of the display sub-devices (including the display sub-devices corresponding to the partial region) can be driven by the updated data driving signal, so that the display sub-devices can be driven by the updated data driving signal to display.

In some embodiments, the storage device includes a first storage unit and a second storage unit. The first storage unit stores a system program of the display apparatus (such as an operating system corresponding to the display apparatus), and the second storage unit stores the updated program. The first storage unit and the second storage unit are independent of each other. The updated program can be independent of the system program, is not destroyed when the system program (such as the operating system) is reinstalled or upgraded, and can be operated separately. For example, the adjustment device issues a control command to update a first updated program stored in the second storage unit to a second updated program (the second updated program can be an updated version of the first updated program, etc.). This process does not involve the operation of the system program (such as the operating system), and the use efficiency of the updated program operation can be improved.

In some embodiments, the display apparatus further includes a detecting device and a processing device.

The detecting device can detect the first image displayed according to the initial display parameter to obtain the detection data. The detecting device may be a sensor or a camera. For example, a high-precision camera can be used to capture the display of the first image, thereby acquiring the detection data. The detection data is information actually displayed by the display device. The information reflects the actual display status of the display device. The display effect of the display device can be adjusted according to the detection data. In some embodiments, each of the display sub-devices can display according to the same display parameter, including the same gray scale parameter and/or the same color parameter. In this way, the imbalance of displaying the first image can be fully presented, so that the detecting device can conveniently obtain accurate detection data, and it is also convenient for the processing device to process the acquired detection data.

In addition, the detection data can also be externally imported into the display device and then obtained by the detecting device. In some embodiments, the detection data may be regarded as more accurate detection data after being verified on the same type of display device, so that it can be directly imported into the current display device for acquisition by the detecting device. In this way, the detection process can be eliminated, thereby improving the detection efficiency.

The processing device can process the detection data, and determine an adjustment region in the first image according to a processing result to determine a partial region of the first image and determine a corresponding adjusted display parameter. In some embodiments, after the display device displays according to adjusted display parameter, the display effect of some regions may not be well adjusted. The processing device may re-optimize the display of the display device according to the processing result. The adjustment device can re-determine the adjusted display parameter. Thereby, the display device can further improve the display image of the display device according to the newly generated adjusted display parameter.

In some embodiments, the detecting device can perform a re-detection on the display device according to the display result corresponding to the adjusted display parameter to regenerate the detection data. The detecting device can repeatedly detect the display of the display device and generate corresponding detection data, and each time the detection data is generated, the detection data can be sent to the processing device, and processed by the processing device.

The processing device can process the regenerated detection data, redetermine a partial region of the first image and/or readjust the display parameters. In some embodiments, the processing device reprocesses the detection data generated by the detecting device to generate a new adjusted display parameter. The new adjusted display parameter can be used by the display device, and the detecting device redetects the display of the display device. The detecting device and the processing device cooperates with each other to complete an optimization process and may repeat this process or repeat this process based on the results of the last optimization process, thereby enabling precise determination of partial regions of the first image and/or adjustment of display parameters. Also, the updated program can be accurately determined, and only the optimized updated program is used in the subsequent application.

In some embodiments, the detecting device includes a plurality of display parameter sensing units. The plurality of display parameter sensing unit is disposed on a light-emitting side of the display device to detect display parameters of the display device, thereby obtaining detection data. The detecting device may include an acquisition device. The acquisition device can acquire the displayed image to obtain the detection data. The display region of the display device is within the acquisition region of the acquisition device, or the display region of the display device can be reflected to the acquisition device by a reflecting member.

In some embodiments, the display parameter sensing unit may be an image sensor (e.g., a brightness sensor). The brightness sensor can be disposed outside the display device, that is, near the side on which the user observes, so as to directly sense display features (such as gray scale information) of the display device, and obtain direct data. The detecting device may also be a collecting device such as a camera. For example, a plurality of high-precision cameras can take a large number of captures about the display features (e.g., gray scale information) of the display device to obtain high-precision detection data. In some embodiments, the cameras can be coupled to the display device by wire or wirelessly. The camera can be installed at the edge of the display device and disposed facing the display device to capture the first image. In some embodiments, the camera is placed opposite to the display device and can directly capture the display device displaying the first image to obtain the detection data. In some embodiments, the camera can also capture the reflected light of the display image that is incident on the display device in a mirror, to obtain the detection data indirectly. The camera can be directly disposed on the display device and the shooting direction is toward the displaying direction of the display device. In this way, the camera is easy to install, and the overall appearance of the display device is beautiful.

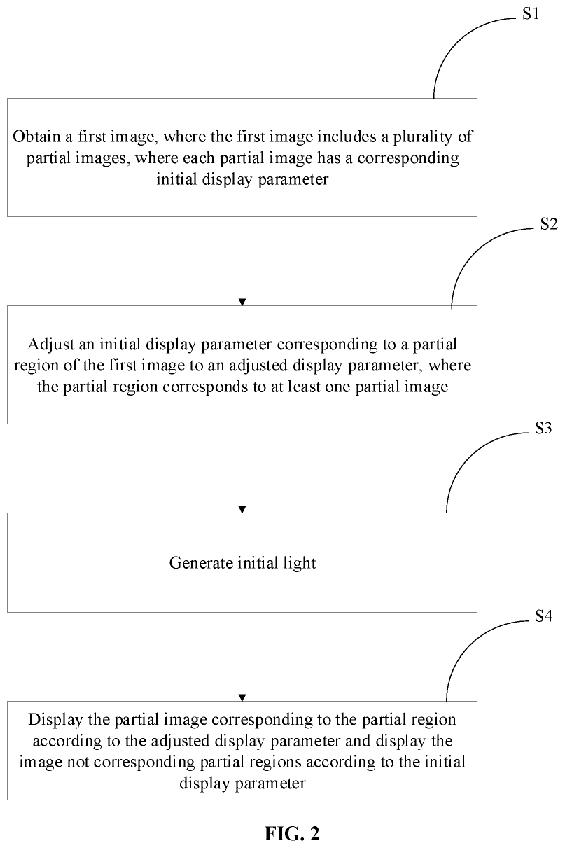

Another aspect of the present disclosure also provides a display method, which can be applied to a television, a display, etc., having a display device. As shown in FIG. 2, the method includes obtaining a first image (at S1), where the first image includes a plurality of partial images. Each partial image has a corresponding initial display parameter. The display device may be connected to the electronic device through the interface device. In some embodiments, the interface device may be a wired interface device. For example, the display device can be connected to the electronic device in a wired manner. In some other embodiments, the interface device may be a wireless interface device. For example, the display device can be connected to the electronic device in a wireless manner. In some embodiments, the interface device can be used as a display interface to enable the display device to display based on received display data. In some other embodiments, the interface device can also be used as a general-purpose data interface to enable the display device to interact with the electronic device. In some embodiments, the interface device may be one type or a combination of various types of interfaces of the display device. The interface device may be an HDMI interface, a VGA interface, a DP interface and/or a USB interface, etc. The first image may be an image to be displayed by the display device. The first image may include the plurality of partial images. The plurality of partial images may include an image having a display effect is different from that of other regions in the first image. As such, the display of the first image can be partially adjusted. Each partial image can be displayed according to the display parameter. The plurality of partial images and other images of the first image can be displayed based on the display parameter.

The method also includes adjusting an initial display parameter corresponding to a partial region of the first image to an adjusted display parameter (at S2), where the partial region corresponds to at least one partial image. The display device may have various structural configurations. The thin and light display device may include LED backlight sources. Light can be illuminated from the LED backlight sources. Without being adjusted by the adjustment device, the display device performs display according to initial display parameter. Due to the limitation of the structure (e.g., the thin and light structure) of the display device, the actual display effect of background lights illuminated by the light-emitting device may not be uniform in partial regions. For example, the gray scale of partial regions of the region illuminated by the LED backlight source is not uniform, for example, stronger in the center but weaker in the edges. For another example, a color display effect in partial regions is different from that a color display effect in other regions. In some embodiments of the present disclosure, the adjustment device can adjust the initial display parameters corresponding to the partial regions to the adjusted display parameter. The display device can performance display in the partial regions according to the adjusted display parameter, so as to adjust the display effect in the partial regions of the first image. The adjusted display parameters can be obtained in different manners. In some embodiments, the adjusted display parameters can be obtained according to the type of the display device and some corresponding empirical data. In some other embodiments, the adjusted display parameters can be obtained using the initial display parameter. For example, when the first image is displayed according to the initial display parameters, the display effect of the first image may not be uniform. Starting from the display effect, the value of the initial display parameter is gradually changed until the display effect displayed by the display device is unified, thereby obtaining the adjusted display parameter.

The method also includes generating initial light (at S3). The initial light may be generated by a single light-emitting device or may be generated by a plurality of light-emitting units in the light-emitting device, where each of the light-emitting units generates respective light. The light-emitting device may include different kinds of light-emitting sources, for example, the LED light source (an LED light bulb). The backlight emitted by the light source of the light-emitting device can illuminate on an illumination region, so as to allow the display device to use the backlight for display. For example, the display device can use the backlight to vary a brightness of a pixel displayed by the display device. For the light-emitting devices with different configurations, the light-emitting source thereof may be different. For example, the display device may be a display device with a direct-type structure, or a display device with a side-type structure. The light-emitting device may include a plurality of LED light sources (e.g., LED light bulbs). The plurality of LED light sources for emitting backlight can be arranged uniformly at an inner side of the display device, or arranged uniformly on edges of the display device. In some embodiments, main features of each LED light source may be similar. For example, the light emitted by each LED light source can be emitted with the same brightness, but the illumination direction or angle of the emitted light can be different and set according to actual application.

The method also includes displaying the partial image corresponding to the partial region according to the adjusted display parameter and displaying the image not corresponding partial regions according to the initial display parameter (at S4). After the initial light illuminates on the display device, the display device can use the initial light illuminating thereon for display. In some embodiments, the display device includes a plurality of display sub-devices, each of the plurality of display sub-devices can use the initial light for display. All of the display sub-devices are displayed to form an image for the viewer to review. During display, each display sub-device can display according to the display parameter. Display sub-devices corresponding to different display parameters may have different display effects. The viewer can perceive the image light of the corresponding display parameter. When the corresponding display parameter changes, the image light perceived by the viewer is also different. In some embodiments, the display sub-devices corresponding to the partial regions can display according to the adjusted display parameters, and the display sub-devices not corresponding to the partial regions can display according to the initial display parameters. As such the display sub-device of the corresponding partial regions performs display according to the adjusted display parameter, the actual display characteristics (such as gray scale or color, etc.) of the partial region can be improved.

In some embodiments, the display method further includes generating a corresponding updated data driving signal based on the adjusted display parameter to display the partial region using the updated data driving signal (at S5). In some embodiments, the display parameter cannot be directly used to drive the display device. The converting unit can convert the display parameter into the corresponding data driving signal, and the data driving signal can be directly used to drive the display device, which includes driving the display sub-device corresponding to the partial region, or drive the display sub-device corresponding to other regions. After the converting unit processes data driving signal corresponding to the initial display parameter into an updated data driving signal based on the adjusted display parameter, the updated data driving signal may be called each time the display device is powered on. For example, the adjustment device transmits the updated data driving signal to the display device, such that the display device uses the updated data driving signal to display. The display sub-device corresponding to the partial region can uses the updated data driving signal to display the partial region.

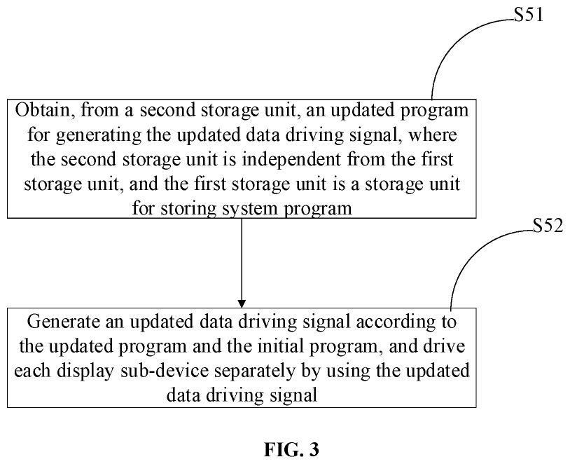

As shown in FIG. 3, generating the corresponding updated data driving signal based on the adjusted display parameter so as to use the updated data driving signal to display in the partial region includes obtaining an updated program for generating the updated data driving signal (S51).

A first storage unit and a second storage unit are independent of each other. The first storage unit is a storage unit for storing system program. The second storage unit is a storage unit for storing updated program. The updated program can be independent of the system program, is not destroyed when the system program (such as the operating system) is reinstalled or upgraded, and can be operated separately. For example, a first updated program stored in the second storage unit can be updated to a second updated program (the second updated program can be an updated version of the first updated program, etc.) according to a control command. This process does not involve the operation of the system program (such as the operating system), and the use efficiency of the updated program operation can be improved. The second storage unit may be a device such as an EEPROM of the display device, and the updated program may be burned into the EEPROM.

The method further includes generating an updated data driving signal according to the updated program and the initial program, and driving each display sub-device separately by using the updated data driving signal (at S52). For example, after the display device initiates or receives a command, the display device calls the updated program from the storage device (e.g., from the EEPROM). In some embodiments, the adjustment device loads the updated program into the initial program after calling the updated program, thereby changing the initial program. For example, after the adjustment device loads the updated program into the initial program, partial program segments in the initial program can be adjusted, added, and/or deleted, etc., so as to change the signal generated by executing the program. In some embodiments, after the updated program is loaded, the initial program can be changed to a current program, and the updated data driving signal can be generated after the current program is executed. In some other embodiments, the updated program and the initial program are executed to generate a first data driving signal and a second data driving signal, respectively. The first data driving signal is first used to drive the display device. After all the display sub-devices display, the second data driving signal is used to drive the display device to display, and to adjust a display status of a part of the display sub-devices. A result of executing the program (e.g., executing the initial program, the updated program, and/or the current program) can be digital signal. The updated data driving signal can be an analog signal. The data signal can be converted into the corresponding analog signal by a driving chop. Each of the display sub-devices (including the display sub-devices corresponding to the partial region) can be driven by the updated data driving signal, so that the display sub-devices can be driven by the updated data driving signal to display.

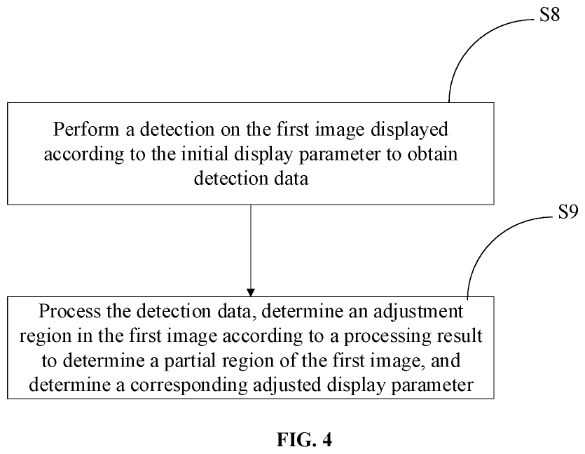

In some embodiments, as shown in FIG. 4, the display method further includes performing a detection on the first image displayed according to the initial display parameter to obtain detection data (at S8).

The detecting device may be a sensor or a camera. For example, a high-precision camera can be used to capture the display of the first image, thereby acquiring the detection data. The detection data is information actually displayed by the display device. The information reflects the actual display status of the display device. The display effect of the display device can be adjusted according to the detection data. In some embodiments, each of the display sub-devices can display according to the same display parameter, including the same gray scale parameter and/or the same color parameter. In this way, the imbalance of displaying the first image can be fully presented, so that the detecting device can conveniently obtain accurate detection data, and it is also convenient for the processing device to process the acquired detection data.

In addition, the detection data can also be externally imported into the display device and then obtained by the detecting device. In some embodiments, the detection data may be regarded as more accurate detection data after being verified on the same type of display device, so that it can be directly imported into the current display device for acquisition by the detecting device. In this way, the detection process can be eliminated, thereby improving the detection efficiency.

The method further includes processing the detection data, determining an adjustment region in the first image according to a processing result to determine a partial region of the first image, and determining a corresponding adjusted display parameter (at S9). In some embodiments, after the display device displays according to adjusted display parameter, the display effect of some regions may not be well adjusted. The processing device may re-optimize the display of the display device according to the processing result. The adjustment device can re-determine the adjusted display parameter. Thereby, the display device can further improve the display image of the display device according to the newly generated adjusted display parameter.

In some embodiments, the first image displayed according to the adjusted display parameter is detected again to obtain the detection data. That is to say, the display of the display device is repeatedly detected, corresponding detection data is generated, and the detection data is reprocessed each time the detection data is generated.

The detection data is processed again, and a partial region of the first image and/or an adjusted display parameter are determined based on the processing result. In some embodiments, the processing device reprocesses the detection data generated by the detecting device to generate a new adjusted display parameter. The new adjusted display parameter can be used by the display device, and the detecting device redetects the display of the display device. The detecting device and the processing device cooperates with each other to complete an optimization process and may repeat this process or repeat this process based on the results of the last optimization process, thereby enabling precise determination of partial regions of the first image and/or adjustment of display parameters. Also, the updated program can be accurately determined, and only the optimized updated program is used in the subsequent application.

The above embodiments are merely exemplary embodiments of the present disclosure, and are not intended to limit the disclosure, and the scope of the disclosure is defined by the claims. A person skilled in the art may make various modifications or equivalents to the disclosure within the spirit and scope of the disclosure, and such modifications or equivalents are also considered to fall within the scope of the present disclosure.

What is claimed is:

1. A display apparatus comprising:
an interface device, configured to obtain a first image, wherein the first image includes a plurality of partial images, each of the plurality of partial image corresponding to an initial display parameter;
an adjustment device, configured to adjust the initial display parameter corresponding to a partial region of the first image to an adjusted display parameter, wherein the partial region corresponds to at least one of the plurality of partial images;
a light-emitting device configured to generate initial light; and
a display device located in an illumination region of the initial light, and including a plurality of display sub-devices, each of the plurality of display sub-devices being configured to display according to a display parameter, wherein a display sub-device corresponding to the partial region is configured to display according to the adjusted display parameter, and a display sub-device not corresponding to the partial region is configured to display according to the initial display parameter.

2. The display apparatus of claim 1, wherein
the light-emitting device includes a plurality of light-emitting units for generating light; and
a light-emitting unit corresponds to a set of display sub-devices, the set of display sub-devices being located in an illumination region of the at least one light-emitting unit;
wherein:
in response to the display sub-device corresponding to the partial region displays according to the initial display parameter, the display sub-device transmits a first light transmission amount; and
in response to the display sub-device corresponding to the partial region displays according to the initial display parameter, the display sub-device transmits a second light transmission amount, the second light transmission amount being greater than the first light transmission amount.

3. The display apparatus of claim 1, wherein:
the display parameter comprises a grayscale parameter; and
the adjustment device is further configured to adjust an initial gray scale parameter corresponding to the partial region to an adjusted gray scale parameter.

4. The display apparatus of claim 3, wherein the adjustment device includes:
a converting unit, configured to process an initial data driving signal of the initial display parameter into an updated data driving signal based on the adjusted display parameter, and send the updated data driving signal to the display device to allow the display sub-device to use the updated data driving signal for display.

5. The display apparatus of claim 4, further comprising a storage device, wherein:
the storage device is configured to store an updated program for generating the updated data driving signal; and
the adjustment device is further configured to:
call the updated program from the storage device;
generate the updated data driving signal according to the initial program and the updated program; and
drive each of the display sub-devices by using the updated data driving signal for display.

6. The display apparatus of claim 5, wherein the storage device further comprises:
a first storage unit configured to store a system program of the display device; and
a second storage unit configured to store the updated program, the first storage unit and the second storage unit being independent of each other.

7. The display apparatus of claim 1, further comprising:
a detecting device, configured to detect the first image displayed according to the initial display parameter to obtain detection data; and
a processing device, configured to process the detection data to generate a processing result, determine an adjustment region in the first image according to the processing result, determine the partial region of the first image, and determine the adjusted display parameter corresponding to the partial region.

8. The display apparatus of claim 7, wherein:
the detecting device is further configured to perform a re-detection on the display device according to a display result corresponding to the adjusted display parameter to regenerate the detection data; and
the processing device is configured to process the regenerated detection data, and determine the partial region of the first image or the adjusted display parameter.

9. The display apparatus of claim 7, wherein:
the detecting device comprises a plurality of display parameter sensing units, and the display parameter sensing unit being disposed on an image light emitting side of the display device and configured to detect the display parameter of the display device to obtain the detection data.

10. The display apparatus of claim 7, wherein:
the detecting device comprises an acquisition device configured to acquire the displayed image to obtain the detected data, wherein a display region of the display device is within an acquisition region of the collecting device, or the display region of the display device is reflected to the acquisition device by a reflecting member.

11. A display method comprising:
obtaining a first image, wherein the first image includes a plurality of partial images, each of the plurality of partial image corresponding to an initial display parameter; and
adjusting the initial display parameter corresponding to a partial region of the first image to an adjusted display parameter,
wherein:
the partial region corresponds to at least one of the plurality of partial images;
one of the plurality of partial images corresponding to the partial region is displayed according to the adjusted display parameter; and
one of the plurality of the partial images not corresponding to the partial region is displayed according to the initial display parameter.

12. The method of claim 11 further comprising:
generating an updated data driving signal based on the adjusted display parameter; and
displaying, driven by the updated data driving signal, the partial region.

13. The method of claim 12, further comprising:
obtaining an updated program for generating the updated data driving signal;
generating the updated data driving signal according to the initial program and the updated program; and
driving each of the display sub-devices by using the updated data driving signal for display,
wherein a system program is stored in a first storage unit, and the updated program is stored in a second storage unit, the first storage unit and the second storage unit being independent of each other.

14. The method of claim 11 further comprising:
detecting the first image displayed according to the initial display parameter to obtain detection data; and
processing the detection data to generate a processing result, determining an adjustment region in the first image according to the processing result, determining the partial region of the first image, and determining the adjusted display parameter corresponding to the partial region.

15. The method of claim 14 further comprising:
performing a re-detection on the display device according to a display result corresponding to the adjusted display parameter to regenerate the detection data; and
processing the regenerated detection data, and determine the partial region of the first image or the adjusted display parameter.

16. The method of claim 11, wherein:
in response to the display sub-device corresponding to the partial region displays according to the initial display parameter, the display sub-device transmits a first light transmission amount; and
in response to the display sub-device corresponding to the partial region displays according to the initial display parameter, the display sub-device transmits a second light transmission amount, the second light transmission amount being greater than the first light transmission amount.

17. The method of claim 11, further comprising:
adjusting an initial gray scale parameter corresponding to the partial region to an adjusted gray scale parameter.

18. The method of claim 17, further comprising:
processing an initial data driving signal of the initial display parameter into an updated data driving signal based on the adjusted display parameter, and sending the updated data driving signal to the display device to allow the display sub-device to use the updated data driving signal for display.

19. A display method comprising:
obtaining a first image, the first image including a plurality of partial images, wherein a partial region corresponds to at least one of the plurality of partial images;
displaying one of the plurality of partial images not corresponding to the partial region according to a first display parameter; and
displaying one of the plurality of partial images corresponding to the partial region according to a second display parameter different from the first display parameter.
